(19) United States
(12) Patent Application Publication
(10) Pub. No.: US 2007/0092315 A1
(43) Pub. Date: Apr. 26, 2007

(54) Image forming apparatus

(76) Inventor: Testu Koyama, Tokyo (JP)

Correspondence Address: RABIN & Berdo, PC, 1101 14TH STREET, NW, SUITE 500, WASHINGTON, DC, 20005, US

(21) Appl. No.: 11/257,132

(22) Filed: Oct. 25, 2005

(51) Int. Cl. G03G 21/00

(52) U.S. Cl. 399/349; 399/358

(57) ABSTRACT

A cleaning apparatus is used for cleaning the surface of a photoconductive body. Residual toner on a rotating photoconductive body is collected after transferring a toner image from the photoconductive body onto a print medium, the apparatus includes a first cleaning member, a second cleaning member, and a toner transporting member. The first cleaning member engages the photoconductive body to brush away the residual toner. The second cleaning member is disposed downstream of the first cleaning member with respect to rotation of the photoconductive body. The second cleaning member scrapes the residual toner off the photoconductive body. The toner transporting member is disposed between the first cleaning member and the second cleaning member along a circumferential surface of the photoconductive body. The toner transporting member is positioned with a gap between the photoconductive body and the toner transporting member and transporting the residual toner removed from the photoconductive body.

### BACKGROUND OF THE INVENTION

1. Field of the Invention

The present invention relates to an image forming apparatus such as an electrophotographic recording apparatus, and more particularly to a cleaning apparatus that removes residual toner remaining on a photoconductive body after transfer of a toner image.

2. Description of the Related Art

A conventional electrophotographic recording apparatus uses an electrophotographic image forming process. A charging unit charges the surface of a rotating photoconductive body uniformly. Then, an exposing unit illuminates the charged surface of the photoconductive body in accordance with print data to form an electrostatic latent image. A developing unit supplies toner to the electrostatic latent image to develop the electrostatic latent image into a toner image. A transfer unit transfers the toner image onto a print medium, which in turn is fused into a permanent image in a fixing unit. A cleaning member is provided downstream of a transfer unit with respect to the direction of rotation of the photoconductive body. The developing unit is detachably attached to the image forming apparatus. Additionally, a fresh toner reservoir may be detachably attached to the developing unit.

A small amount of toner remains adhering to the photoconductive body after transferring the toner image onto the print medium. In order to remove the toner from the photoconductive body, a cleaning blade is provided in abutting relation with the photoconductive body. The cleaning blade scrapes the toner from the photoconductive body. The toner scraped by the cleaning blade is held in a residual toner chamber below the cleaning blade. The aforementioned conventional cleaning apparatus requires a relatively large chamber near the photoconductive body for collecting the toner scraped by the cleaning blade. Providing a relatively large chamber for merely holding useless toner is detrimental to miniaturizing the image forming apparatus.

### SUMMARY OF THE INVENTION

An object of the invention is to solve the aforementioned drawbacks of the conventional apparatus and to provide an electrophotographic recording apparatus that reliably collects residual toner from the surface of a photoconductive body.

Another object of the invention is to provide a cleaning unit that has the good ability to transport collected toner irrespective of environmental conditions, and that does not cause soiling of a printed medium.

Still another object of the invention is to provide a cleaning unit that can be applied to image forming apparatuses such as copying machines, LED printers, laser beam printers, facsimiles, and MFPs.

A cleaning apparatus is used for cleaning the surface of a photoconductive body. Residual toner on a rotating photoconductive body is collected after transferring a toner image from the photoconductive body onto a print medium. The apparatus includes a first cleaning member, a second cleaning member, and a toner transporting member. The first cleaning member engages the photoconductive body to brush away the residual toner. The second cleaning member is disposed downstream of the first cleaning member with respect to rotation of the photoconductive body. The second cleaning member scrapes the residual toner off the photoconductive body. The toner transporting member is disposed between the first cleaning member and the second cleaning member along a circumferential surface of the photoconductive body. The toner transporting member is positioned with a gap between the photoconductive body and the toner transporting member, and transports the residual toner removed from the photoconductive body.

The first cleaning member rotates about a rotational axis substantially parallel to a first rotational axis of the photoconductive body, and engages the circumferential surface of the photoconductive body to brush away the residual toner. The second cleaning member rotates about a second rotational axis substantially parallel to the rotational axis of the photoconductive body, and engages the circumferential surface of the photoconductive body to scrape the residual toner off the photoconductive body.

The cleaning apparatus further includes an engagement portion. The first cleaning member may be a brush having bristles that engage the circumferential surface of the photoconductive body to brush away the residual toner off the photoconductive body. When the first cleaning member rotates, the engagement portion engages the bristles and then releases the bristles so that the bristles vibrate to shake the residual toner off the bristles.

The first cleaning member, second cleaning member, and toner transporting member are disposed such that

Lb≦15 mm,

La≦=15 mm,

Lc≦15 mm, and

La+Lc≦25 mm

where a point “d” and a point “b” are points on the toner transporting member and photoconductive body lying on a line that passes through the centers of the photoconductive body and the toner transporting member, Lb is a line that connects the point “d” and the point “b”, Lc is a line that connects the point “d” and a point “c” at which the cleaning blade abuts the photoconductive body, and La is a line that connects the point “d” and a point “a” at which the cleaning blade abuts the photoconductive body.

The cleaning apparatus further includes a solid lubricant disposed such that tip portions of the bristles engage the solid lubricant as the first cleaning member rotates.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates an image forming apparatus according to the present invention;

FIG. 2 illustrates the positional relationships among a cleaning brush, a toner transporting member, and a cleaning blade according to a first embodiment;

FIG. 3 illustrates a cleaning unit according to the first embodiment;

FIG. 4 is a perspective view illustrating the positional relationship between a cleaning brush and a toner transporting member;

FIG. 5 illustrates the cleaning unit in detail;

FIG. 6 illustrates Table 1 that lists the toner-transporting performance for the collected toner;

FIG. 7 illustrates Table 2 that shows in terms of distances La and Lc how efficiently the collected toner is transported;

FIG. 8 is a side view illustrating the cleaning unit and a developing unit according to a second embodiment;

FIG. 9 illustrates a pertinent portion of a cleaning unit according to the second embodiment;

FIG. 10 is a side view illustrating a cleaning unit and a developing unit according to a third embodiment;

FIG. 11 illustrates a pertinent portion of the cleaning unit according to the third embodiment; and

FIG. 12 illustrates a pertinent portion of a modification to the third embodiment.

### DETAILED DESCRIPTION OF THE INVENTION

Preferred embodiments will be described in detail with reference to the accompanying drawings.

### First Embodiment

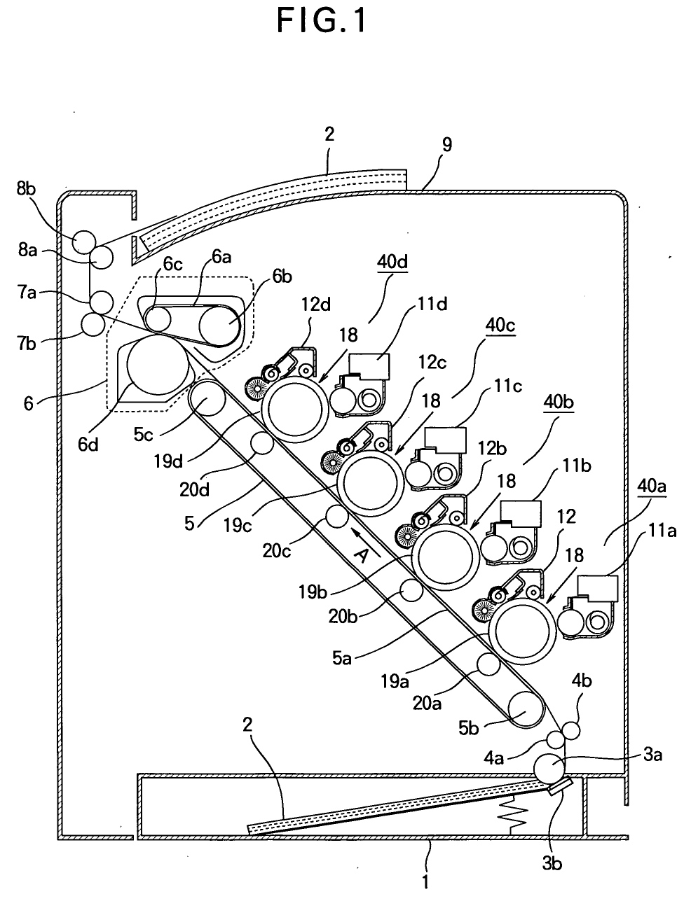

FIG. 1 illustrates an image forming apparatus according to the present invention. Image forming sections 40a-40d are aligned along a transfer belt 5a of a transfer unit 5, and form yellow, magenta, cyan, and black images, respectively. The image forming sections 40a-40d are aligned from a lower right corner to an upper left corner in such a way that the preceding one of adjacent ones is above the following one of the adjacent ones. The image forming sections 40a-40d include developing units 11a-11d and cleaning units 12a-12d, respectively. Developing rollers of the developing units 11a-11d are in pressure contact with the photoconductive bodies 19a-19d, respectively. The cleaning units 12a-12d abut the photoconductive bodies 19a-19d, respectively, to collect residual toner from the photoconductive bodies 19a-19d.

A medium tray 1 holds a stack of medium 2 therein. A separator roller 3a cooperates with a separator tongue 3b to separate a top page from the stack of medium 2, and feeds the top page to transporting rollers 4a and 4b. The transporting rollers 4a and 4b transport the page of medium 2 to the transfer belt 5a. The transfer unit 5 includes the transfer belt 5a, a drive roller 5c, an idle roller 5b, and transfer rollers 20a-20d. The transfer belt 5a is entrained about the drive roller 5c and the idle roller 5b. When the transfer roller 5c rotates, the transfer belt 5a passes through the image forming sections sequentially in a direction shown by arrow A with the page of medium 2 placed thereon. The transfer rollers 20a-20d transfer toner images of the respective colors onto the photoconductive bodies 19a-19d, respectively. A fixing unit 6 includes a heat roller 6b, an idle roller 6c, and a fixing belt 6a entrained about the heat roller 6b and idle roller 6c, and fixes the toner images transferred onto the page of medium 2. The fixing belt 6a is held between the idle roller 6c and the pressure roller 6d in a sandwiched relation. A heater may be used to heat the idle roller 6c. The page of medium 2 leaves the fixing unit and is discharged to a stacker 9 by discharge rollers 7a, 7b, 8a, and 8b.

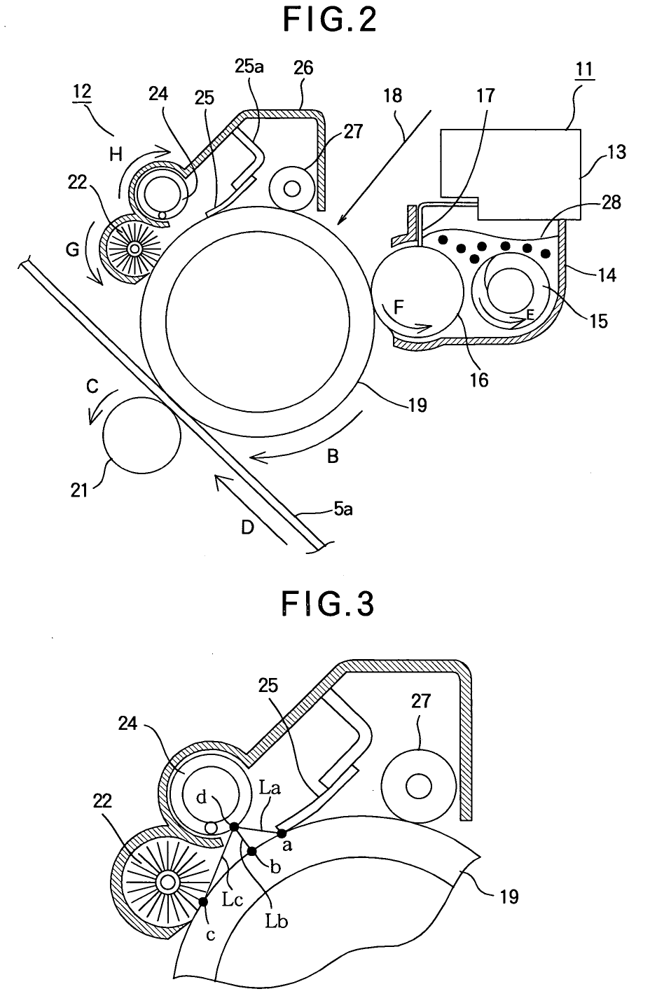

Referring to FIG. 2, a cleaning brush 22, a toner transporting member 24, and a cleaning blade 25 are disposed along the circumferential surface of the photoconductive body 19. The developing unit 11 includes a housing 14, a toner chamber 13, a toner transporting member 15, and a developing roller 16. The toner 15 is a screw conveyor that extends in its longitudinal direction, and transports the toner from the middle of the developing unit 11 to the ends of the developing unit 11. The developing roller 16 supplies fresh toner 28 to the photoconductive body 19. A developing blade 17 forms a thin layer of fresh toner 28 on the surface of the developing roller 16.

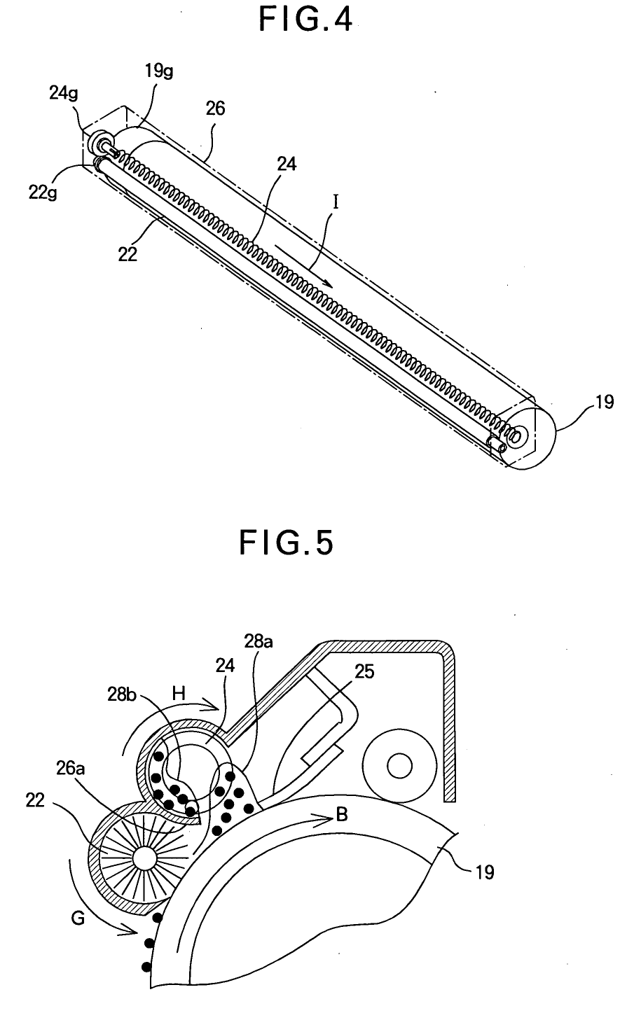

The photoconductor body 19 extends in its longitudinal direction parallel to its rotational axis. A drive force is transmitted to the photoconductive body 19 through a gear 19a (FIG. 4) mounted to one longitudinal end portion of the photoconductive body 19, so that the photoconductive body 19 rotates in a direction shown by arrow B. The transfer roller 21 is disposed in such a way that the transfer belt 20 is held between the transfer roller 21 and the photoconductive body 19 in a sandwiched relation. The photoconductive body 19 and transfer roller 21 rotate in directions shown by arrows B and C, respectively, so that when the transfer belt 5a runs in a direction shown by arrow D, the toner image is transferred from the photoconductive body 19 onto the page of medium 2 placed on the transfer belt 5a.

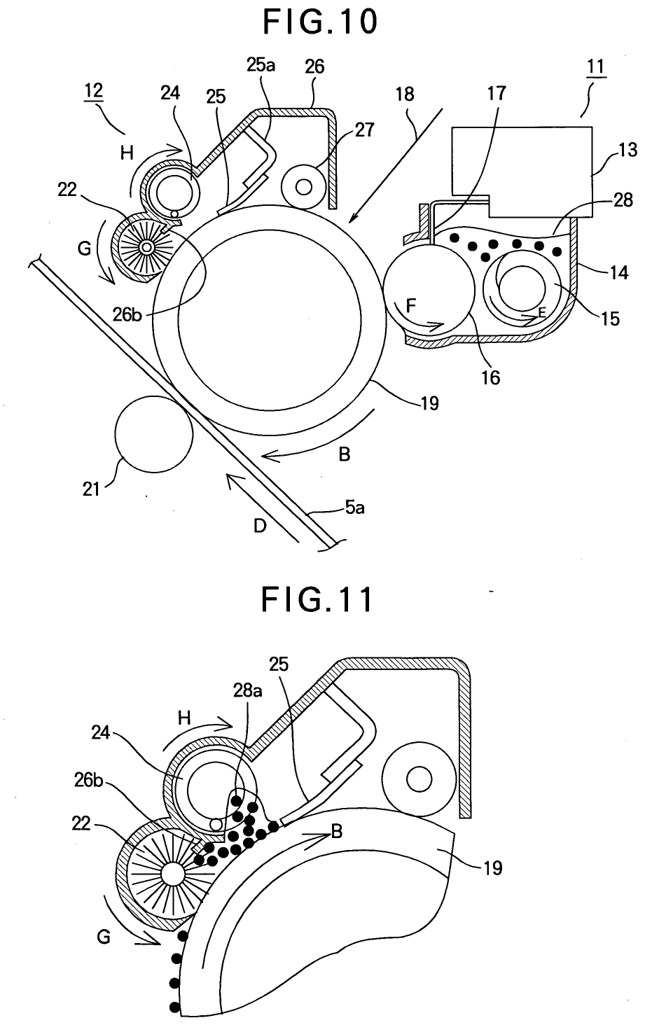

The cleaning units 12a-12d abut the photoconductive bodies 19a-9d, respectively, to collect the residual toner from the photoconductive bodies 19a-9d. The cleaning brush 22 is made from, for example, nylon, and has bristles whose free ends engage the photoconductive body 19. The cleaning brush 22 extends in its longitudinal direction, which is parallel to a rotational axis of the cleaning brush 22, and has a gear 22g (FIG. 4) mounted to one longitudinal end of the cleaning brush 22. The gear 22g is in mesh with the gear 19g of the photoconductive body 19. The toner transporting member 24 is, for example, a coil of stainless steel, and is disposed with a predetermined gap between the photoconductive body 19 and the toner transporting member 24. The toner transporting member 24 extends in its longitudinal direction, which is parallel to a rotational axis of the toner transporting member 24. The toner transporting member 24 includes a gear 24g (FIG. 4), which in turn is in mesh with the gear 22g of the cleaning brush 22. The cleaning blade 25 is made of a resilient material such as urethane, and its one end abuts the photoconductive body 19. A sheet metal member 25a (FIG. 2) supports the cleaning blade 25 in position. A charging roller 27 rotates in contact with the surface of the photoconductive body 19, and charges the photoconductive body 19. A cover 26 defines an outer wall that encloses the cleaning brush 22, cleaning blade 25, charging roller 27, and toner transporting member 24. The cover 26 includes a rib 26b (FIG. 10) that projects in such a way that the rib 26b abuts the tip portions of bristles of the cleaning brush 22. The rib 26b extends in its longitudinal direction, which is parallel to the length of the cleaning brush 22.

The cleaning brush 22, cleaning blade 25, toner transporting member 24, and photoconductive body 19 are disposed such that

Lb≦10 mm, La≦15 mm, Lc≦15 mm, and La+Lc≦25 mm

where a point “d” and a point “b” are points on the toner transporting member 24 and photoconductive body 19 lying on a line that passes through the centers of the photoconductive body 19 and the toner transporting member 24, Lb is a line that connects the point “d” and the point “b,” Lc is a line that connects the point “d” and a point “c” at which the cleaning brush 22 abuts the photoconductive body 19, and La is a line that connects the point “d” and a point “a” at which the cleaning blade 25 abuts the photoconductive body 19.

When the image forming apparatus receives a printing command from an external apparatus, not shown, the separator roller 3a cooperates with the separator tongue 3b to separate a top page of medium 2, and feeds it to the transport rollers 4a and 4b. The transport rollers 4a and 4b transport the page of medium 2 to the transfer belt 5a, which in turn runs through the respective image forming sections with the page placed thereon. At this moment, the exposure light 18 illuminates the charged surfaces of the photoconductive bodies 19a-19d in accordance with print data. The potential of the areas on the photoconductive bodies exposed to the exposure light 18 decreases to nearly zero volts.

The toner transporting member 15 in the developing unit 11 is rotated by a drive source, not shown, in a direction shown by arrow E, thereby supplying the toner to the developing roller 16. The developing blade 17 forms a thin layer of toner on the developing roller 16 and causes the toner to be charged. Because the photoconductive body 19 continues to rotate, the thin layer of toner on the developing roller 16 is attracted to the exposed areas on the photoconductive body 19 so that the electrostatic latent image on the photoconductive body 19 is developed into a toner image.

This toner image is transferred by the transfer roller 21 onto the page of medium 2 that is being transported by the transfer belt 20 in the D direction. Then, the medium 2 is transported to the fixing unit 6 where the toner image is fused into a permanent image. The medium 2 is discharged by the transport rollers 7a, 7b, 8a, and 8b onto a stacker 9 provided on the outer surface of the image forming apparatus.

FIG. 4 is a perspective view illustrating the positional relationship between the cleaning brush 22 and the toner transporting member 24. After transferring the toner image onto the page of medium 2, a small amount of toner remains on the photoconductive body 19. The drive force is transmitted to the cleaning brush 22 through the gear 22g, and drives the cleaning brush 22 to rotate in a direction shown by arrow G (FIG. 2), so that the cleaning brush 22 brushes away the residual toner on the photoconductive body 19. The circumferential speed of the cleaning brush 22 is selected to be the same as or greater than that of the photoconductive body 19. The cleaning blade 25 is in pressure contact with the surface of the photoconductive body 19 to scrape the residual toner from the photoconductive body 19. A drive force is transmitted to the toner transporting member 24 through the gear 24g, and drives the toner transporting member 24 to rotate in a direction shown by arrow H (FIG. 2), so that the toner transporting member 24 transports the residual toner removed from the photoconductive body 19 in a direction shown by arrow I. Then, the collected residual toner is discharged through an outlet.

FIG. 5 illustrates the cleaning unit 12 in detail. The cleaning brush 22 and cleaning blade 25 remove residual toner 28a from the photoconductive body 19. The residual toner 28a removed from the photoconductive body 19 stays in a space between the toner transporting member 24 and cleaning blade 25. When the toner transporting member 24 rotates in the H direction, part of the residual toner 28a moves to a rib 26a that projects into a space enclosed by the cover 26, and is discharged as a collected toner 28b through an outlet. In other words, the toner transporting member 24 transports the residual toner 28a so that the residual toner 28a will not accumulate in the space between the toner transporting member 24 and the cleaning blade 25.

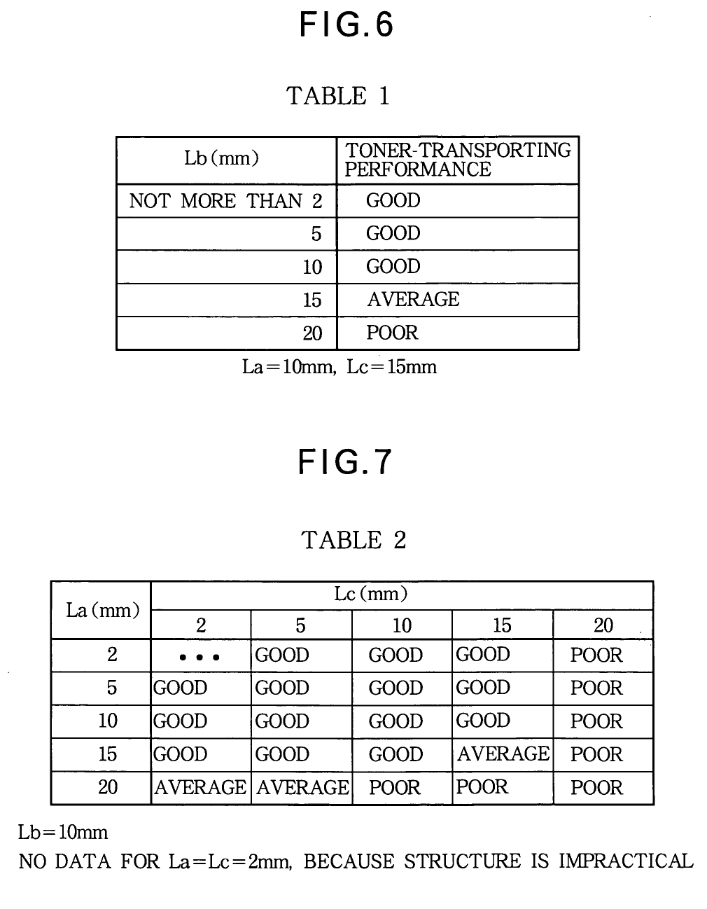

FIG. 6 illustrates Table 1 that lists the toner-transporting performance for the collected toner 28b. The performance was evaluated by printing at a print duty of 5% and causing the photoconductive body to make 30,000 rotations. “Good” represents a satisfactory result irrespective of environmental conditions. “Poor” indicates that the toner fails to be properly collected and causes poor cleaning results and hence soiling of printed results (not dependent on the environmental conditions). “Average” indicates that the toner fails to be collected when the apparatus operates in a high-temperature and high humidity (28° C., 80%) environment, causing poor cleaning results and hence poor print quality. Table 1 reveals that for Lb not more than 10 mm, good toner transporting performance is obtained and no soiling of printed results occurs in any environmental conditions at which the cleaning unit operates.

FIG. 7 illustrates Table 2 that shows in terms of La and Lc how efficiently the collected toner 28b is transported. Table 2 shows that good toner transporting performance can be obtained irrespective of the environmental conditions for Lb≦10 mm, La≦15 mm, Lc≦15 mm, and La+Lc≦=25 mm. The cleaning apparatus takes less volume than prior art apparatus, lending itself to the miniaturization of the image forming apparatus. Polymerization toner has a relatively small diameter and therefore a high cleaning performance is required of a cleaning apparatus. Thus, the present invention can be applicable to apparatuses that use polymerization toner, lending itself to high cleaning performance.

### Second Embodiment

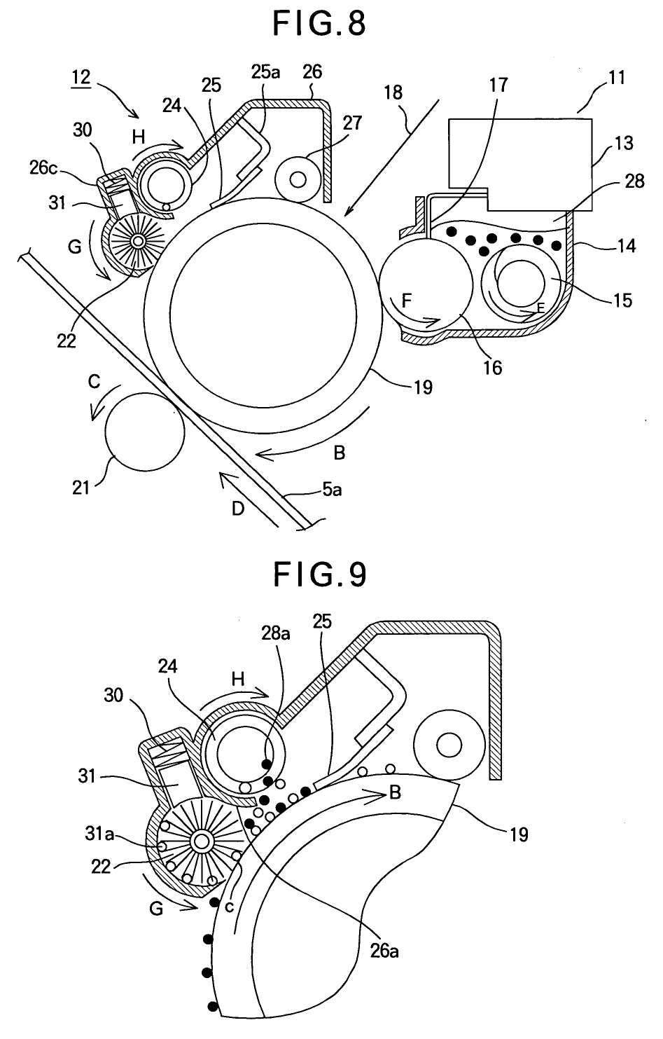

FIG. 8 is a side view illustrating the cleaning unit and the developing unit according to a second embodiment. The toner transporting member 24 and a mounting portion 26c that accommodates a solid lubricant 31 are disposed to surround the cleaning brush 22. The mounting portion 26c is downstream of the toner transporting member 24 with respect to a direction shown by arrow G, i.e., the direction of rotation of the cleaning brush 22. The mounting portion 26c accommodates the solid lubricant 31 and a resilient member 30 therein. The resilient member 30 urges the lubricant 31 against the tips of the bristles of the cleaning brush 22. The lubricant 31 is made by first melting a lubrication oil additive that contains zinc stearate as a major component, and then cooling it to a solid state. The rest of the configuration of the second embodiment is the same as that of the first embodiment and the description thereof is omitted.

FIG. 9 illustrates a pertinent portion of a cleaning unit according to a second embodiment. Referring to FIG. 9, fine particles 31a of the lubricant 31 adhere to the bristles of the cleaning brush 22. The cleaning brush 22 supplies an amount of the fine particles 31a to the surface of the photoconductive body 19 at a point upstream of the contact point “c,” and removes the residual toner 28a from the photoconductive body 19 at a point downstream of the contact point “c.” The fine particles 31a adhering to the photoconductive body 19 are not thoroughly scraped off the photoconductive body 19 by the cleaning blade 25 but a small amount of the fine particles 31a remains on the photoconductive body 19. The rest of the operation of the second embodiment is the same as that of the first embodiment and the description thereof is omitted.

The fine particles 31a deposited on the surface of the photoconductive body 19 serve to decrease the friction on the surface f the photoconductive body 19, facilitating easy removal of the residual toner from the photoconductive body 19. The lubricant 31 is disposed downstream of the toner transporting member 24 with respect to the G direction. Thus, after the cleaning brush 22 has pushed the residual toner 28a removed from the photoconductive body 19 toward the toner transporting member 24, the lubricant 31 adheres to the tip portions of the bristles of the cleaning brush 22. For this reason, the removed residual toner 28a will not stay at a location where the lubricant 31 is disposed. Thus, the lubricant 31 can be easily supplied to the surface of the photoconductive body 19. The residual toner 28a is apt to adhere to the bristles of the cleaning brush 22 in the vicinity of the surface of the photoconductive body 19. Therefore, the lubricant 31 is disposed as away from the surface of the photoconductive body 19 as possible so that the residual toner 28a will not adhere to the bristles but the particles of the lubricant 31 will adhere. In this manner, some uniform amount of the lubricant 31 can be supplied to the photoconductive body 19 constantly. The rest of the advantages of the second embodiment are the same as those of the first embodiment and the description thereof is omitted.

### Third Embodiment

FIG. 10 is a side view illustrating a cleaning unit and a developing unit according to a third embodiment. Referring to FIG. 10, a flicker 26b is located downstream with respect to the rotation of the cleaning brush 22 at a point at which a cleaning brush 22 engages a photoconductive body 19. The flicker 26b is provided on a part of a cover 26, and extends in its longitudinal direction, which is parallel to the rotational axis of the cleaning brush 22. The length of the flicker 26b is the same as or longer than the cleaning brush 22. The flicker 26b is positioned so that when the cleaning brush 22 rotates, the flicker 26b can engage the tip portions of the bristles of the cleaning brush 22 or enter into the bristles. When the cleaning brush 22 rotates, the flicker 26b interferes with the tip partitions of the bristles, causing the bristles to first flex resiliently and then releasing the bristles so that the bristles vibrate to shake the toner particles off the bristles. The rest of the configuration of the third embodiment is the same as that of the first embodiment and the description thereof is omitted.

FIG. 11 illustrates a pertinent portion of the cleaning unit according to the third embodiment. Referring to FIG. 11, the cleaning brush 22 engages the surface of the photoconductive body 19 to brush away the residual toner 28a on the photoconductive body 19. Because the flicker 26b engages the tip portions of the bristles of the cleaning brush 22, the toner can be brushed away even though the residual toner adheres to the tip portions of the bristles or enters into the bristles. Thus, the toner particles will not be trapped among the bristles or remain adhered to the bristles, not deteriorating the ability of the bristles to brush away the residual toner 28a from the surface of the photoconductive body 19. The rest of operation and advantages are the same as those of the first embodiment.

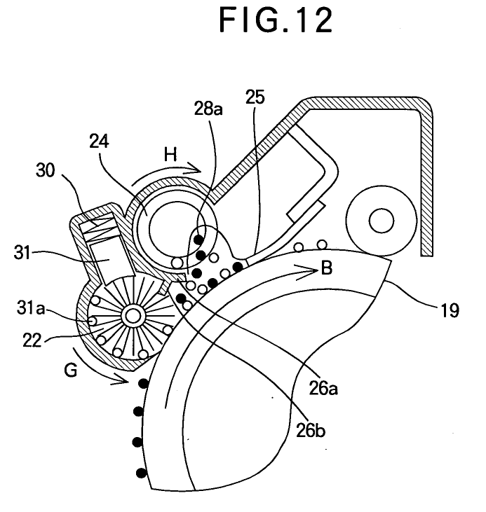

FIG. 12 illustrates a pertinent portion of a modification of the third embodiment. This modification is a combination of the configuration of the third embodiment and the mounting portion 26c, solid lubricant 31, and the resilient member 30 of the second embodiment. The rest of the operation and advantages of the modification is the same as those of the second and third embodiments and the description thereof is omitted. The present invention is applicable to an image forming apparatus used in, for example, a copying machine, an LED printer, a laser beam printer, a facsimile machine, and an MFP.

What is claimed is:

1. An image forming apparatus in which residual toner on a rotating photoconductive body is collected after transferring a toner image from the photoconductive body onto a print medium, the apparatus comprising:
a first cleaning member that extends in parallel with the photoconductive body and engages the photoconductive body to collect the residual toner;
a second cleaning member disposed downstream of said first cleaning member with respect to rotation of the photoconductive body, said second cleaning member scraping the residual toner off the photoconductive body;
a toner transporting member disposed between said first cleaning member and said second cleaning member along a circumferential surface of the photoconductive body, said toner transporting member being positioned with a gap between the photoconductive body and said toner transporting member and transporting the residual toner removed from the photoconductive body.

2. The image forming apparatus according to claim 1, wherein said first cleaning member rotates about a rotational axis substantially parallel to a first rotational axis of the photoconductive body and engages the circumferential surface of the photoconductive body to brush away the residual toner,
wherein said second cleaning member rotates about a second rotational axis substantially parallel to the rotational axis of the photoconductive body and engages the circumferential surface of the photoconductive body to scrape the residual toner off the photoconductive body.

3. The image forming apparatus according to claim 2, wherein said first cleaning member, second cleaning member, and toner transporting member are disposed such that
Lb≦15 mm,
La≦15 mm,
Lc≦15 mm, and
La+Lc≦25 mm
where a point “d” and a point “b” are points on the toner transporting member and photoconductive body and lying on a line on a line that passes through the centers of the photoconductive body and the toner transporting member, Lb is a line that connects the point “d” and the point “b,” Lc is a line that connects the point “d” and a point “c” at which the cleaning blade abuts the photoconductive body, and La is a line that connects the point “d” and a point “a” at which the cleaning blade 25 abuts the photoconductive body.

4. The image forming apparatus according to claim 2 further comprises an engagement portion;
wherein said first cleaning member is a brush having bristles that engages the circumferential surface of the photoconductive body to brush away the residual toner off the photoconductive body,
wherein when said first cleaning member rotates, the engagement portion engages the bristles and then releases the bristles so that the bristles vibrate to shake the residual toner off the bristles.

5. The image forming apparatus according to claim 1, further comprising an engagement portion,
wherein said first cleaning member is a brush having bristles;
wherein when said first cleaning member rotates, the engagement portion engages the bristles such that the bristles vibrate to shake the toner particles off the bristles.

6. The image forming apparatus according to claim 5, further comprising a solid lubricant disposed such that tip portions of the bristles engage the solid lubricant as said first cleaning member rotates.
